(19) United States
(12) Patent Application Publication
(10) Pub. No.: US 2007/0013984 A1
(43) Pub. Date: Jan. 18, 2007

(54) Active compensation device, and compatible optical pickup and optical recording and/or reproducing apparatus employing the active compensation device

(75) Inventors: Tae-kyung Kim, Seoul (KR); Woo-seok Choi, Seoul (KR); Jin-won Lee, Seongnam-si (KR); Tao Hong, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/486,109

(22) Filed: Jul. 14, 2006

(30) Foreign Application Priority Data
Jul. 15, 2005 (KR) 2005-64452

(51) Int. Cl. G03H 1/12

(52) U.S. Cl. 359/11

(57) ABSTRACT

An active compensation device, and a compatible optical pickup and an optical recording and/or reproducing apparatus employing the active compensation device, are compatible with information storage media standards specifying different thicknesses and light having the same wavelength. The active compensation device includes two transparent substrates; a material layer interposed between the transparent substrates and having a refractive index that is actively switched according to a voltage applied to the material layer; and a holographic pattern formed adjacent to the material layer on a surface of at least one of the transparent substrates to control a divergence angle of incident light by transmitting the incident light without diffraction or diffracting the incident light according to the refractive index of the material layer.

### CROSS-REFERENCE TO RELATED PATENT APPLICATION

This application claims the benefit of Korean Patent Application No. 2005-64452 filed on Jul. 15, 2005, in the Korean Intellectual Property Office, the disclosure of which is incorporated herein by reference in its entirety.

### BACKGROUND OF THE INVENTION

1. Field of the Invention

An aspect of the invention relates to an optical pickup and an optical recording and/or reproducing apparatus employing the same, and more particularly to a compatible optical pickup capable of accommodating information storage media complying with different standards, which use the same light source but have different thicknesses, using one objective lens, and an optical recording and/or reproducing apparatus employing the compatible optical pickup.

2. Description of the Related Art

Optical recording and/or reproducing apparatuses record information on and/or reproduce information from an information storage optical disc by focusing a light beam incident on and/or reflected from the optical disc with an objective lens. In optical recording and/or reproducing apparatuses, a recording capacity is determined by a size S of the focused light spot. The size S of the focused light spot is related to a wavelength (λ) of the light and a numerical aperture (NA) of the objective lens in the following equation:
S∝λ/NA (1)

Accordingly, to form a small light spot for high-density recording, it is essential to adopt a blue laser as a light source to emit light having a short wavelength, and an objective lens having a high NA.

The Blu-ray disc (BD) standard uses a light source with a wavelength of approximately 405 nm, an objective lens with an NA of 0.85, and an optical disc with a capacity of about 25 gigabytes (GB) and a thickness of 0.1 mm (a distance between a light incident surface and an information storage surface, corresponding to the thickness of a protective layer). The high-definition digital versatile disc (HD DVD) standard uses a light source with the same wavelength of approximately 405 nm that is used in the BD standard, an objective lens with an NA of 0.65, and an optical disc with a capacity of about 15 GB and a thickness of about 0.6 mm (an interval between a light incident surface and an information storage surface, corresponding to the thickness of a substrate).

Therefore, a device compatible with these two optical disc standards is needed.

DVD standards, such as DVD-RAM and DVD±RW standards, use light sources with the same wavelengths, objective lenses with the same NAs, and optical disc substrates with the same thicknesses. In these standards, only a track pitch and an optical disc structure are different. Accordingly, since an operation of condensing light emitted from a light source onto optical discs complying with these standards is almost the same regardless of the optical disc standard, a method of performing focusing and tracking that is compatible with various track pitches has been developed.

However, since the thicknesses of the optical discs are different in the next-generation DVD standards such as the BD and HD DVD standards, the generation of spherical aberration due to the difference in the thicknesses of the optical discs is severe. Accordingly, it is necessary to compensate for the spherical aberration.

To compensate for the spherical aberration caused by the difference in the thicknesses of the optical discs when one light source is used, a method using a holographic optical element (HOE) and a method using two objective lenses have been developed.

Japanese Patent Application Publication No. 8-62493 discloses a method of compatibly reproducing CDs using a DVD light source. However, in this method, light emitted from one light source is diffracted by an HOE into two light beams, that is, a zeroth-order light beam and a first-order light beam, and thus optical efficiency is reduced by half.

Japanese Patent Application No. 8-252697 discloses a method using a sliding-shaft-type actuator and two objective lenses. However, this method is complex and has a low sensitivity and a high non-linearity, and thus is not suitable for high-speed and high-precision optical recording and/or reproducing apparatuses.

Japanese Patent Application Publication No. 2002-319172 discloses a method of actively adjusting a phase of light incident on and reflected from an optical disc using liquid crystal devices. Since a pair of concentric liquid crystal devices must be used due to their polarization characteristics, costs are high and the intensity of light detected by a photodetector is very likely to vary due to a concentricity error between the two liquid crystal devices with respect to optical discs of different standards.

### SUMMARY OF THE INVENTION

In accordance with an aspect of the invention, an active compensation device changes a divergence angle of light by actively switching a refractive index of a material layer to selectively transmit incident light without diffraction or diffract the incident light.

In accordance with an aspect of the invention, a compatible optical pickup employs the active compensation device, which makes it possible to reduce costs while having little effect on light intensity detected by a photodetector by using a single light source, a single objective lens, and a single active compensation device with a high optical efficiency to achieve compatibility with different information storage media standards specifying light having the same wavelength. In accordance with an aspect of the invention, an optical recording and/or reproducing apparatus employs the compatible optical pickup

In accordance with an aspect of the invention, an active compensation device includes two transparent substrates; a material layer interposed between the transparent substrates and having a refractive index that is actively switched according to a voltage applied to the material layer; and a holographic pattern formed adjacent to the material layer on a surface of at least one of the transparent substrates to control a divergence angle of incident light by transmitting the incident light without diffraction or diffracting the incident light according to the refractive index of the material layer.

The material layer may be a liquid crystal layer having a refractive index that is actively switched according to the voltage applied to the material layer.

The refractive index of the material layer may be actively switched according to the voltage applied to the material layer to be equal to or different from a refractive index of the lat least one of the transparent substrates on which the holographic pattern is formed.

A difference Δn between a refractive index of the at least one of the transparent substrates on which the holographic pattern is formed and the refractive index of the material layer, a depth d of the holographic pattern, a wavelength λ of the incident light, and an order m of diffracted produced by the holographic pattern may the following equation:
(Δn·λ−1)d=m·λ.

The active compensation device may further include a numerical aperture adjusting holographic pattern formed at an outer circumference of the holographic pattern.

When the voltage applied to the material layer is a first voltage, the refractive index of the material layer may substantially equal to a refractive index of the at least one of the transparent substrates on which the holographic pattern is formed, thereby causing the holographic pattern to transmit the incident light without diffraction; and when the voltage applied to the material layer is a second voltage different from the first voltage, the refractive index of the material layer may be different from the refractive index of the at least one of the transparent substrates on which the holographic pattern is formed, thereby causing the holographic pattern to diffract the incident light.

In accordance with an aspect of the invention, an optical pickup includes a light source that emits light having a predetermined wavelength; an objective lens that focuses incident light originating from the light source on an information storage medium and is compatible with a first information storage medium standard that specifies a first thickness and light having the predetermined wavelength; an optical path changer, interposed between the light source and the objective lens, that changes an optical path of light traveling to and from the objective lens; a photodetector that receives light that is reflected by the information storage medium and passes through the objective lens and the optical path changer; the active compensation device described above, interposed between the optical path changer and the objective lens, that actively controls an angle at which the incident light originating from the light source is incident on the objective lens to make the objective lens compatible with both the first information storage medium standard and a second information storage medium standard that specifies a second thickness different from the first thickness and light having the predetermined wavelength; and a wave plate interposed between the optical path changer and the active compensation device, that changes a polarization of light traveling to and from the active compensation device.

The optical pickup may further include a numerical aperture adjusting holographic pattern, formed at an outer circumference of the holographic pattern, that adjusts a numerical aperture of the objective lens so that the objective lens has a first numerical aperture specified by the first information storage medium standard when the information storage medium complies with the first information storage medium standard, and has a second numerical aperture specified by the second information storage medium standard when the information storage medium complies with the second information storage medium standard.

The predetermined wavelength of the light source may be in a range of 400-420 nm, the first thickness specified by the first information storage medium standard may be 0.1 mm, the first numerical aperture specified by the first information storage medium standard may be substantially 0.85, the second thickness specified by the second information storage medium standard may be 0.6 mm, and the second numerical aperture specified by the second information storage medium standard may be substantially 0.65.

The predetermined wavelength of the light source may be in a range of 400-420 nm, the first information storage medium standard may be a Blu-ray disc (BD) standard, and the second information storage medium standard may be a high-definition digital versatile disc (HD DVD) standard.

The optical path changer may be a polarization-dependent optical path changer.

When the voltage applied to the material layer is a first voltage, the refractive index of the material layer may substantially equal to a refractive index of the at least one of the transparent substrates on which the holographic pattern is formed, thereby causing the holographic pattern to transmit the incident light without diffraction so that the incident light originating from the light source is incident on the objective lens at a first angle to make the objective lens compatible with the first information storage medium standard; and when the voltage applied to the material layer is a second voltage different from the first voltage, the refractive index of the material layer may be different from the refractive index of the at least one of the transparent substrates on which the holographic pattern is formed, thereby causing the holographic pattern to diffract the incident light so that the incident light originating from the light source is incident on the objective lens at a second angle different from the first angle to make the objective lens compatible with the second information storage medium standard.

When the holographic pattern transmits the incident light without diffraction, the incident light originating from the light source may be incident on the objective lens as a parallel light beam; and when the holographic pattern diffracts the incident light, the incident light originating from the light source may be incident on the objective lens as a diverging light beam.

In accordance with an aspect of the invention, an optical recording and/or reproducing apparatus includes the optical pickup described above, disposed to be movable at least in a radial direction of an information storage medium; and a control unit the optical pickup to record information on and/or reproduce information from the information storage medium.

In accordance with an aspect of the invention, an optical pickup includes a single light source that emits light having a predetermined wavelength specified by a first information storage medium standard and a second information storage medium standard different from the first information storage medium standard; a single objective lens that is compatible with the first information storage standard but is not compatible with the second information storage medium standard; and a single active compensation device, interposed between the single light source and the single objective lens, that transmits incident light originating from the single light source without modification when a first information storage medium complying with the first information storage medium standard is being used so that the single objective lens focuses the unmodified incident light on the first information storage medium without aberration, and modifies the incident light originating from the single light source when a second information storage medium complying with the second information storage medium standard is being used so that the single objective lens focuses the modified light on the second information storage medium without aberration, thereby making the single objective lens compatible with the second information storage medium standard.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of embodiments of the invention, taken in conjunction with the accompanying drawings of which:

FIG. 1 is a sectional view of an active compensation device according to an aspect of the invention;

FIG. 2 is a plan view of a holographic pattern of the active compensation device of FIG. 1 according to an aspect of the invention;

FIGS. 3A and 3B are sectional views for explaining the operating principle of the active compensation device of FIG. 1 according to an aspect of the invention;

FIG. 4 shows the optical arrangement of a compatible optical pickup employing an active compensation device according to an aspect of the invention;

FIG. 5 shows an optical path of light according to polarization in a compatible optical pickup according to an aspect of the invention when used with an information storage medium having a thickness different from a thickness used in the design of an objective lens;

FIG. 6A shows an optical path of effective light used as signal light which is reflected by an information storage medium toward a photodetector;

FIG. 6B shows an optical path of stray light not used as signal light which is reflected by an information storage medium toward a photodetector;

FIG. 7A shows an optical path of light passing through an active compensation device without being diffracted and then passing through an objective lens to be focused on a Blu-ray disc (BD), where the objective lens 30 is designed for use with a Blu-ray disc (BD) and has a focal length of 2.35 mm under conditions that a wavelength is 408 nm, a numerical aperture (NA) is 0.85, and the thickness of an information storage medium is 0.1 mm;

FIG. 7B shows an optical path of light passing through the active compensation device of FIG. 7A while being diffracted and then passing though the objective lens of FIG. 7A to be focused on a high-definition digital versatile disc (HD DVD);

FIG. 8A shows a light distribution detected by a photodetector in a device in the related art when there is no concentricity error between a liquid crystal device that affects light reflected by an information storage medium to the photodetector and a liquid crystal device that affects light traveling from a light source to the information storage medium;

FIG. 8B shows a light distribution on the photodetector in the device in the related art when there is a concentricity error of 10 μm between the liquid crystal device that affects light reflected by the information storage medium to the photodetector and the liquid crystal device that affects light traveling from the light source to the information storage medium;

FIG. 9 shows a plan view and a sectional view of a blazed-type holographic pattern and a numerical aperture (NA) adjusting holographic pattern formed on a transparent substrate of an active compensation device according to an aspect of the invention; and

FIG. 10 shows an optical recording and/or reproducing apparatus employing a compatible optical pickup according to an aspect of the invention.

### DETAILED DESCRIPTION OF THE EMBODIMENTS

Reference will now be made in detail to embodiments of the invention, examples of which are shown in the accompanying drawings, wherein like reference numerals refer to like elements throughout. The embodiments are described below in order to explain the invention by referring to the figures.

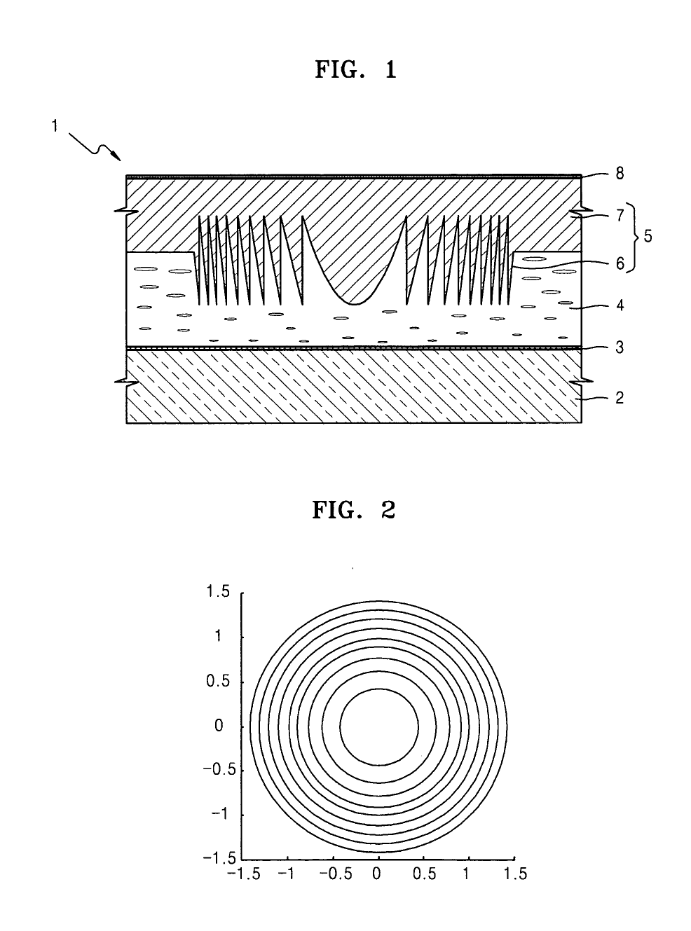

FIG. 1 is a side sectional view of an active compensation device 1 according to an aspect of the invention.

Referring to FIG. 1, the active compensation device 1 includes first and second transparent substrates 2 and 7, a material layer 4 that is interposed between the first and second transparent substrates 2 and 7 and has a refractive index that is actively switched according to an applied voltage, and a holographic pattern 6 formed on at least one of the first and second transparent substrates 2 and 7. Transparent electrodes 3 and 8 for applying a voltage to the material layer 4 are respectively formed on the first and second transparent substrates 2 and 7.

The material layer 4 may be made of an anisotropic material whose refractive index is actively switched according to an applied voltage to be equal to or different from the refractive index of the first or second transparent substrate 2 or 7 on which the holographic pattern 6 is formed with respect to incident light having a specific wavelength, for example, a blue wavelength in a range of 400-420 nm suitable for a Blu-ray disc (BD) and a high-definition digital versatile disc (HD DVD).

The material layer 4 may be a liquid crystal layer whose refractive index is switched according to an applied voltage. When a liquid crystal layer is aligned, the liquid crystal layer has polarization selectivity. That is, the refractive index of the liquid crystal layer can be switched according to an applied voltage only for light polarized in the same direction as a long-axis direction of a liquid crystal director. Since the liquid crystal layer has the same refractive index for light polarized in a direction perpendicular to the long-axis direction of the liquid crystal director even if the applied voltage is changed, the refractive index of the liquid crystal layer is not switched. As a result, if the liquid crystal layer is aligned, the active compensation device 1 has polarization selectivity.

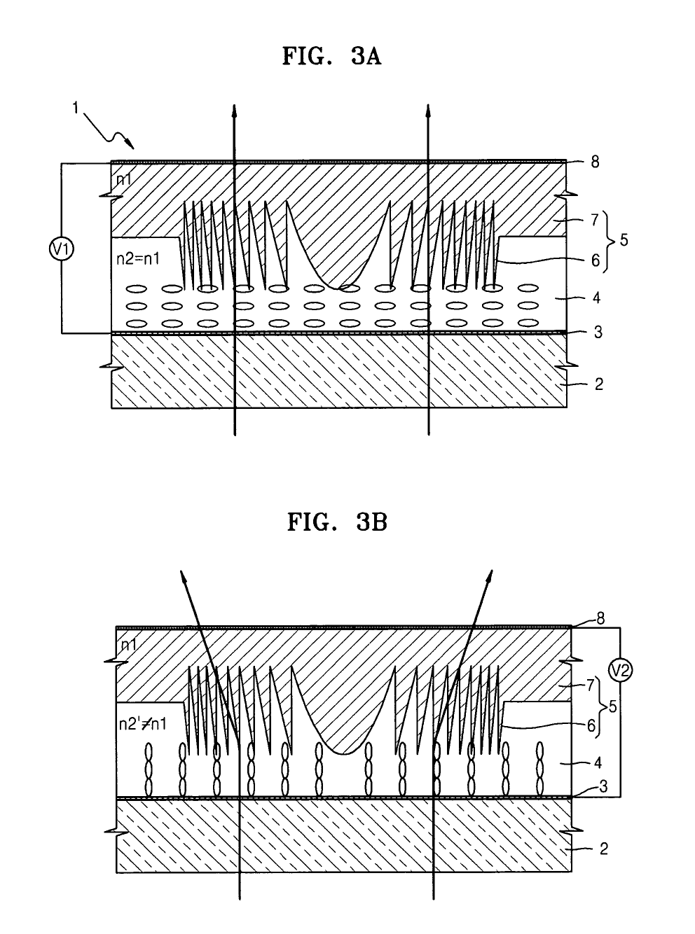

Referring to FIG. 1, and to FIGS. 3A and 3B which will be explained in detail later, the first transparent substrate 2 is disposed on a side on which light is incident and is a flat substrate, and the holographic pattern 6 is formed on the second transparent substrate 7, which is disposed on a side from which light is emitted. The second transparent substrate 7 having the holographic pattern 6 formed thereon is referred to as a holographic substrate 5.

The holographic pattern 6 is formed on a surface of the second transparent substrate 7 adjacent to the material layer 4 to change a divergence angle of incident light passing through the holographic pattern 6 by transmitting the incident light without diffraction or diffracting the incident light according to the refractive index of the material layer 4.

FIG. 2 is a plan view of the holographic pattern 6 of the active compensation device 1 of FIG. 1. FIG. 2 shows examples of radial ranges (in mm) of the holographic pattern 6 in horizontal and vertical directions. Referring to FIG. 2, a radius of 1.5 mm may correspond to a radial range of an objective lens with a numerical aperture (NA) of 0.85 as described later.

Referring to FIGS. 1 and 2, the holographic pattern 6 may be formed to produce a phase distribution that is proportional to the square of the radius, which is the distance from the center of the holographic pattern 6. The holographic pattern 6 is obtained by assigning a value only to C2 and no values to other coefficients among hologram phase coefficients in a rotationally symmetric form. The holographic pattern 6 may be modified according to designing values of the hologram phase coefficients in consideration of design specifications of other optical elements of an optical system to which the active compensation device 1 is applied.

The active compensation device 1 may be formed as follows. For example, after the holographic substrate 5 including the second transparent substrate 7 and the holographic pattern 6 that produces the phase proportional to the square of the radius as shown in FIGS. 1 and 2 is manufactured, the transparent electrode 8 made of indium tin oxide (ITO) or any other suitable material is formed. The transparent electrode 8 may be formed on the surface of the holographic substrate 5 opposite to the surface on which the holographic pattern 6 is formed. Alternatively, the transparent electrode 8 may be formed on the surface of the holographic substrate 5 on which the holographic pattern 6 is formed.

The flat transparent substrate 2 made of glass or any other suitable material is prepared and the transparent electrode 3 is formed thereon of indium tin oxide (ITO) or any other suitable material. An anisotropic material such as a liquid crystal or any other suitable material is sealed between the flat transparent substrate 2 and the holographic substrate 5 to form the material layer 4, thereby completing the active compensation device 1 as shown in FIG. 1.

FIGS. 3A and 3B are sectional views for explaining the operating principle of the active compensation device 1 of FIG. 1.

Referring to FIG. 3A, when a voltage V1 is applied so that the refractive index n1 of the holographic substrate 5 and the refractive index n2 of the liquid crystal are equal or substantially equal to each other, incident light is transmitted without being diffracted. However, referring to FIG. 3B, when a voltage V2 is applied so that the refractive index n1 of the holographic substrate 5 is different from the refractive index n2′ of the liquid crystal, incident light is diffracted by the holographic pattern 6 of the holographic substrate 5. Accordingly, the divergence angle of the incident light is changed so that the incident light is collimated, converged, or diverged. FIG. 3B shows an example where the incident light is diverged. The voltages V1 and V2 may vary according to whether the liquid crystal has a positive or negative refractive index anisotropy, or whether the liquid crystal is aligned horizontally or vertically.

FIG. 3A a case where a parallel light beam incident on the active compensation device 1 is transmitted without being diffracted, and FIG. 3B shows a case where a parallel light beam incident on the active compensation device 1 is diffracted to form a first-order light beam according to the applied voltage.

Diffraction efficiency is related to a difference between the refractive index of the holographic substrate 5 and the refractive index of the liquid crystal, the depth of the holographic pattern 6, and the wavelength of the incident light.

Accordingly, the active compensation device 1 may be formed so that a difference Δn=n1−n2′ between the refractive index n1 of the holographic substrate 5 and the refractive index n2′ of the liquid crystal, which is different from the refractive index n1 of the holographic substrate 5 due to the applied voltage, a depth d of the holographic pattern 6, a wavelength λ of the incident light, and an order m of diffracted light produced by the holographic pattern 6 satisfy the following equation:
(Δn·λ−1)d=m·λ (2)

When the active compensation device 1 satisfies Equation 2, diffraction efficiency is almost 100%.

The active compensation device 1 having the holographic pattern 6 changes a divergence angle of incident light by selectively transmitting the incident light without diffraction or diffracting the incident light according to a change in the refractive index of the material layer 4 due to the applied voltage. When the active compensation device 1 is employed in a compatible optical pickup which will be explained later, the active compensation device 1 can compensate for spherical aberration caused by a difference in thicknesses of information storage media.

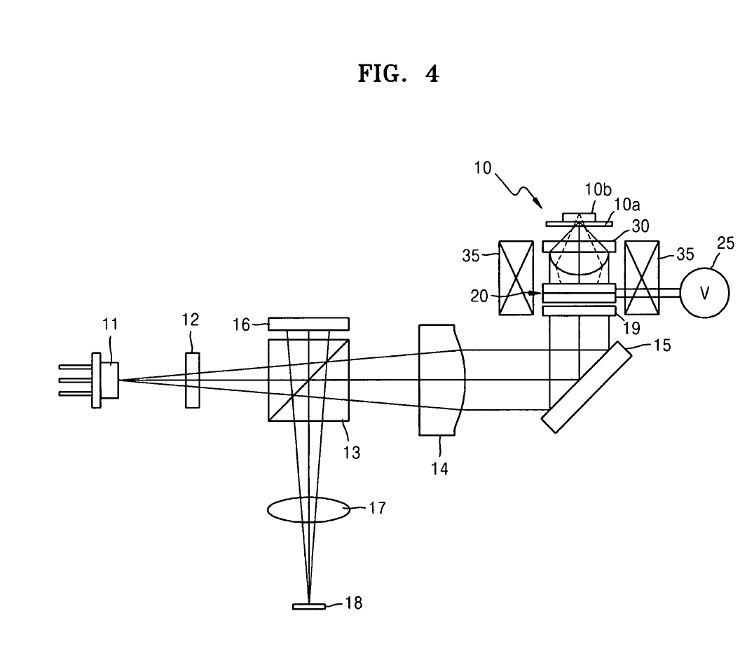

FIG. 4 shows the optical arrangement of a compatible optical pickup employing an active compensation device according to an aspect of the invention. This compatible optical pickup can be used with information storage media complying with different information storage medium standards specifying light having the same wavelength. The compatible optical pickup uses a single light source 11 and a single objective lens 30.

Referring to FIG. 4, the compatible optical pickup includes the light source 11, the objective lens 30 which is compatible with a first information storage medium, e.g., a BD 10a, and focuses light originating from the light source 11 on an information storage medium 10, an optical path changer, interposed between the light source 11 and the objective lens 30, that changes an optical path of light traveling to and from the objective lens 30, a photodetector 18 that receives light that is reflected by the information storage medium 10 and passes through the objective lens 30 and the optical path changer, an active compensation device 20, interposed between the optical path changer and the objective lens 30, that actively controls an angle at which the incident light originating from the light source 11 is incident on the objective lens 30, and a wave plate 19, interposed between the optical path changer and the active compensation device 20, that changes a polarization of light traveling to and from the active compensation device 20.

The light source 11 emits light having a wavelength that is compatible with the first information storage medium, e.g., the BD 10a, and a second information storage medium, e.g., a HD DVD 10b, having a thickness different from a thickness of the BD 10a. For example, when the first information storage medium is the BD 10a and the second information storage medium is the HD DVD 10b, the light source 11 emits light having a blue wavelength in a range of 400-420 nm, for example, 405 nm. The light source 11 may be a semiconductor laser emitting light having a blue wavelength in a range of 400-420 nm, for example, 405 nm.

The objective lens 30 focuses incident light on the information storage medium 10, and may be optimized for the BD 10a. That is, when light having a wavelength in a range of 400-420 nm is incident on the objective lens 30, the objective lens 30 may be designed to focus the incident light on the BD 10a having a thickness of about 0.1 mm to form an optimal light spot on the BD 10a.

The active compensation device 20 may be the active compensation device 1 described with reference to FIGS. 1 through 3B. That is, the active compensation device 20 may include the material layer 4 that is interposed between the two transparent substrates 2 and 7 and has a refractive index that is switched according to a voltage applied from a power source 25. The holographic pattern 6 is formed on a surface of the transparent substrate 2 or 7 contacting the material layer 4 to control a divergence angle of incident light by transmitting the incident light without diffraction or diffracting the incident light according to the refractive index of the material layer 4. When the material layer 4 is an aligned liquid crystal layer, the active compensation device 20 has polarization selectivity. The power source 25 is electrically connected to the material layer 4 interposed between the two transparent substrates 2 and 7 via the transparent electrodes 3 and 8.

When the active compensation device 20 operates to transmit the incident light without diffraction, for example, when the voltage V1 is applied to the material layer 4, the refractive index of the transparent substrate 7 on which the holographic pattern 6 is formed and the refractive index of the material layer 4 adjacent to the transparent substrate 7 having the holographic pattern 6 formed thereon become equal or substantially equal to each other. When the active compensation device 20 operates to change a divergence angle of the incident light by diffracting the incident light, for example, when the voltage V2 is applied to the material layer 4, the refractive index of the transparent substrate 7 on which the holographic pattern 6 is formed and the refractive index of the material layer 4 become different from each other.

Specific examples of the active compensation device 20 applied to the compatible optical pickup according to an aspect of the invention will be explained in detail later in conjunction with an explanation of specific examples of the objective lens 30.

In the compatible optical pickup according to an aspect of the invention, the wave plate 19 is interposed between the optical path changer and the active compensation device 20. The wave plate 19 may be a quarter-wave plate designed for the wavelength of light emitted from the light source 11.

Since the wave plate 19 is interposed between the optical path changer and the active compensation device 20, the compatible optical pickup according to an aspect of the invention can correct spherical aberration caused by a difference in thickness between optical discs complying with different standards using only the active compensation device 20 having one material layer 4. The reason for this will be explained in detail later.

To further increase optical efficiency, the compatible optical pickup according to an aspect of the invention may include a polarization-dependent optical path changer, for example, a polarizing beam splitter 13, as the optical path changer. The polarizing beam splitter 13 selectively transmits or reflects incident light according to the polarization of the incident light. For example, the polarizing beam splitter 13 may transmit first linearly polarized light from the light source 11 to the objective lens 30, and reflect second linearly polarized light reflected by the information storage medium 10 to the photodetector 18.

The compatible optical pickup according to an aspect of the invention may further include a grating 12 that divides light emitted from the light source 11 into at least two light beams and a cylinder lens 17 that helps to detect a focus error signal by an astigmatic method. In FIG. 4, a collimating lens 14 collimates the light emitted from the light source 11, a reflection mirror 15 reflects light so that an optical path is bent, an actuator 35 drives the objective lens 30 in a focusing, tracking, and/or tilt direction, and a monitoring photodetector 16 monitors light output from the light source 11.

The compatible optical pickup constructed as described above operates as follows. When the BD 10a is used, the voltage V1 is applied by the power source 25 to the active compensation device 20, so that the refractive index of the material layer 4 and the refractive index of the transparent substrate 7 with the holographic pattern 6 adjacent to the material layer 4 are equal or substantially equal to each other. Accordingly, a parallel light beam incident on the active compensation device 20 is transmitted through the active compensation device 20 without being diffracted and is then focused by the objective lens 30 to form a light spot on the BD 10a.

When the HD DVD 10b is used, however, the voltage V2 is applied by the power source 25 to the active compensation device 20, so that the refractive index of the material layer 4 and the refractive index of the transparent substrate 7 with the holographic pattern 6 adjacent to the material layer 4 are different from each other. Accordingly, a parallel light beam incident on the active compensation device 20 is diffracted by the holographic pattern 6 to form a first-order light beam, thereby changing a divergence angle of the incident light beam, thereby changing an angle of incidence on the objective lens 30. For example, the diffraction may cause a divergent light beam to be incident on the objective lens 30. The objective lens 30 forms a light spot compensated for spherical aberration that occurs due to a difference in the thickness of the HD DVD 10b and the BD 10a.

The reason why spherical aberration that occurs when optical discs having different thicknesses are recorded and/or reproduced using the same light source can be corrected by the compatible optical pickup according to an aspect of the invention constructed as described above will now be explained.

Most of the light emitted from the light source 11, that is, the semiconductor laser, is linearly polarized in one direction. For example, the emitted light may be P-polarized light. When the polarizing beam splitter 13 is used as the optical path changer, the linearly polarized light emitted from the light source 11 passes through the polarizing beam splitter 13 and travels toward the wave plate 19. A case where 100% of the light emitted from the light source 11 is P-polarized light and the active compensation device 20 acts only for P-polarized light will be explained as an example.

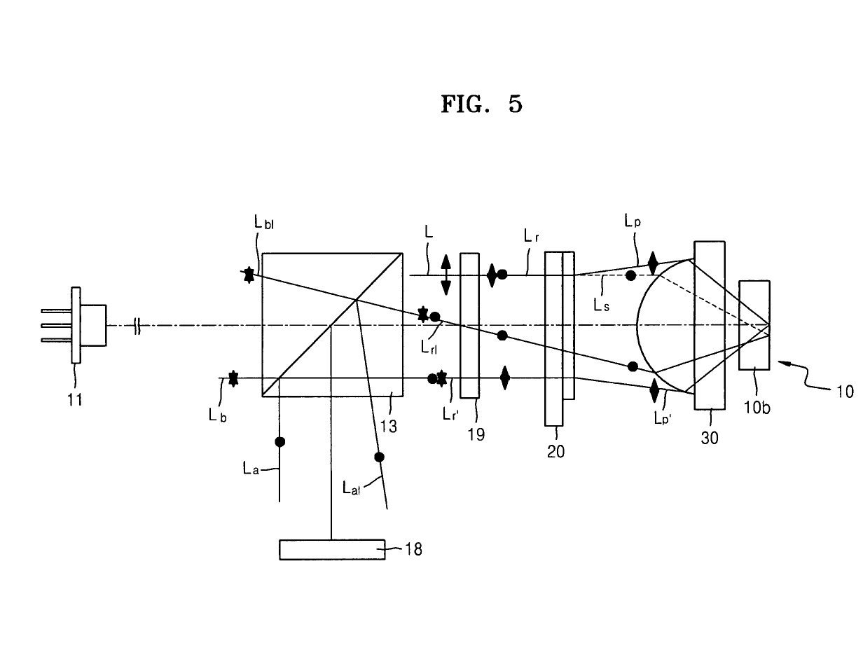

FIG. 5 an optical path of light according to polarization in the compatible optical pickup according to an aspect of the invention when using the HD DVD 10b having a thickness different from a thickness used in the design of the objective lens 30 (which is the thickness of the BD 10a). FIG. 5 shows the optical path of light when the voltage V2 is applied to the material layer 4 of the active compensation device 20 to make the refractive index of the material layer 4 different from the refractive index of the transparent substrate 7 on which the holographic pattern 6 is formed. The incident light is diffracted by the holographic pattern 6. The reflection mirror 15 and the change in the optical path caused by the reflection mirror 15 are not shown in FIG. 5 for convenience of explanation.

Referring to FIG. 5, parallel P-polarized light L emitted from the light source 11 and passing through the polarizing beam splitter 13 is incident on the wave plate 19. The incident parallel P-polarized light L passes through the wave plate 19, thereby being changed to circularly polarized light Lr. The circularly polarized light Lr includes P-polarized light Lp (50%) and S-polarized light Ls (50%).

Accordingly, the P-polarized light Lp incident on the active compensation device 20 passes through the active compensation device 20 after being diffracted to change the divergence angle, and then is incident on the objective lens 30 to be focused on a recording surface of the HD DVD 10b. When the HD DVD 10b having a thickness different from the thickness used in the design of the objective lens 30 is used, spherical aberration caused by the difference in thickness is corrected. The actual optical path is marked by a solid line in FIG. 5.

P-polarized light Lp′ reflected by the information storage medium 10 is incident on the active compensation device 20. The incident P-polarized light Lp′ is collimated by the active compensation device 20 and is incident on the wave plate 19. The incident P-polarized light Lp′ passes through the wave plate 19, thereby being changed to circularly polarized light Lr′. S-polarized light, that is, effective light La, corresponding to 50% of the circularly polarized light Lr′, is reflected by the polarizing beam splitter 13 to the photodetector 18. The effective light La is received by an effective receiving surface of the photodetector 18. P-polarized light Lb corresponding to the remaining 50% of the circularly polarized light Lr′ is transmitted through the polarized beam splitter 13 toward the light source 11 and is lost. Accordingly, about 50% of the light L emitted from the light source 11 is used as effective light focused on the information storage medium 10, and 50% of the effective light, that is, 25% of the light L emitted from the light source 11, is received as effective light by the photodetector 18.

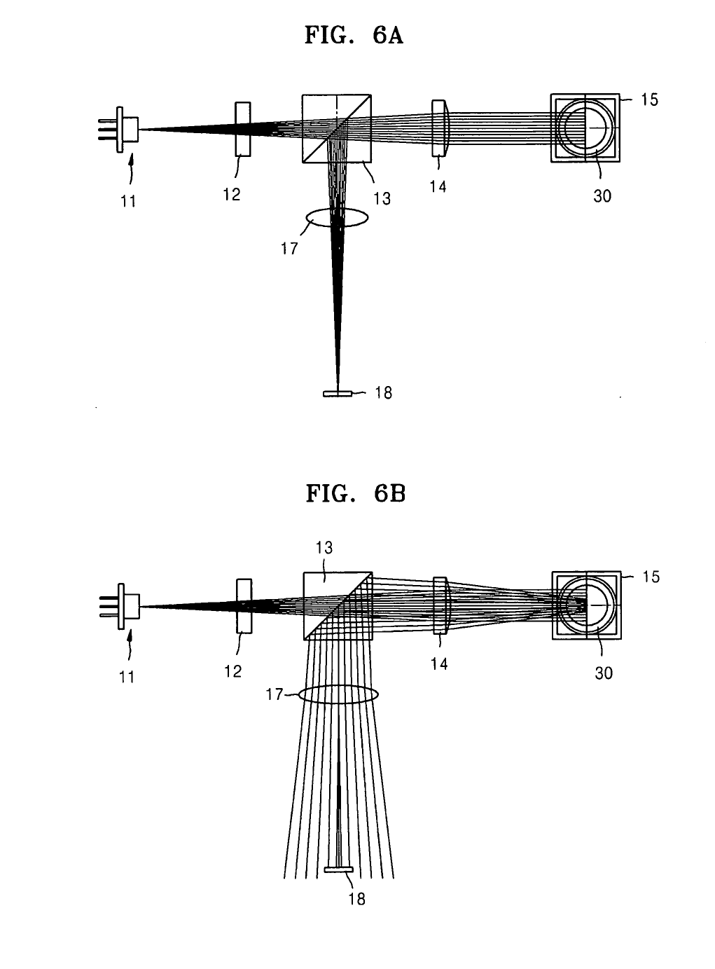

FIGS. 6A and 6B show an optical path of light reflected by the information storage medium 10 toward the photodetector 18. FIG. 6A shows the optical path of the effective light La used as signal light. Referring to FIG. 6A, all of the effective light La reflected by the polarizing beam splitter 13 toward the photodetector 18 is received by the photodetector 18.

The S-polarized light Ls included in the circularly polarized light Lr emitted from the light source 11 and passing through the wave plate 19 is transmitted through the active compensation device 20 without diffraction and thus without a change in its divergence angle, so that the S-polarized light Ls is not focused on the recording surface of the information storage medium 10 and not used as effective light. The optical path of the S-polarized light Ls is marked by a dotted line in FIG. 5.

The S-polarized light Ls transmitted through the active compensation device 20 is reflected by the information storage medium 10 to be incident on the active compensation device 20, and then is transmitted through the active compensation device 20. The S-polarized light Ls passes through the wave plate 19 to become circularly polarized light Lr1. S-polarized light La1 corresponding to 50% of the circularly polarized light Lr1 is reflected by the polarizing beam splitter 13 toward the photodetector 18, and P-polarized light Lb1 corresponding to the remaining 50% of the circularly polarized light Lr1 is transmitted through the polarizing beam splitter 13 toward the light source 11 and is lost. Most of the P-polarized light Lb1 directed toward the photodetector 18 is not incident on the effective receiving surface of the photodetector 18 and is lost as shown in FIG. 6B. Only about 1% or less of the P-polarized light Lb1 is received by the effective receiving surface of the photodetector 18, and therefore it has almost no effect on signal detection. FIG. 6B shows the optical path of stray light which is not used as signal light.

Table 1 below shows the amount of polarized light in each region along the optical path of the compatible optical pickup according to an aspect of the invention according to polarization. In Table 1, “aberration-corrected” denotes light focused on the information storage medium 10 to be used as effective light during recording/reproduction. “Aberration-uncorrected” denotes light not focused on the information storage medium 10 so that it is not used as effective light during recording/reproduction.

TABLE 1

| | | | Passing | Reflected | Passing | | |
|---|---|---|---|---|---|---|---|
| | Emitted | Passing | through | by | through | | |
| | from | through | active | information | active | Passing | |
| | light | wave | compensation | storage | compensation | through | |
| Polarization | source | plate | device | medium | device | wave plate | |
| P | 100% | 50% | 50% | | 50% | 25% | Lb (toward light |
| | | | aberration- | | aberration- | aberration- | source) |
| | | | corrected | | corrected | corrected | |
| | | | | | | 25% | Lb1 (toward light |
| | | | | | | aberration- | source) |
| | | | | | | uncorrected | |
| S | 0% | 50% | 50% | | 50% | 25% | La (inside |
| | | | aberration- | | aberration- | aberration- | effective surface |
| | | | uncorrected | | uncorrected | corrected | of photodetector) |
| | | | | | | 25% | La1 (outside |
| | | | | | | aberration | effective surface |
| | | | | | | uncorrected | of photodetector) |

Specific examples of the objective lens 30 and the active compensation device 20 will now be explained in detail.

Table 2 below shows design examples of the objective lens 30 and the active compensation device 20 applied to the compatible optical pickup according to an aspect of the invention to be compatible with both the BD 10a and the HD DVD 10b.

The data of Table 2 was obtained under the conditions shown in Table 3 below. Referring to Table 3, when the BD 10a with a thickness of 0.1 mm is used, the active compensation device 20 transmits light with a blue wavelength of 408 nm without diffraction (corresponding to zeroth-order diffraction) and the objective lens 30 has an NA of 0.85 and a focal length of 2.35 mm, whereas when the HD DVD 10b with a thickness of 0.6 mm is used, the active compensation device 20 diffracts the incident light to form a first-order light beam, thereby changing a divergence angle of the incident light and thereby changing an angle of incidence on the objective lens 30, and the objective lens 30 has an NA of 0.65 and a focal length of 2.33 mm.

TABLE 2

| | Radius of | Thickness or distance | |
|---|---|---|---|
| Surface | curvature | [mm] | Material (Glass) |
| Object plane | INFINITY | INFINITY | |
| S1 | INFINITY | 0.000000 | |
| S2 | INFINITY | 0.400000 | BK7_Schott |
| S3 | INFINITY | 1.000000 | |
| S4 | INFINITY | 0.500000 | BK7_Schott |
| S5 (HOE) | INFINITY | 0.400000 | BK7_Schott |
| | C1: −3.4700E−03 C2: −9.6866E−04 C3: −1.3708E−04 | | |
| | C4: −9.6395E−06 | | |
| S6 | INFINITY | 0.000000 | |
| S7 | INFINITY | 0.500000 | |
| S8 (STOP) | INFINITY | 0.000000 | |
| S9 (Aspheric) | 1.838415 | 2.860000 | LaF2_HOYA |
| | K: −0.709697 A: 0.668561E−02 B: 0.261545E−03 | | |
| | C: 0.568568E−03 D: −.346785E−03 E: 0.154228E−03 | | |
| | F: −.342724E−04 G: 0.774357E−06 H: 0.107781E−05 | | |
| | J: −.157659E−06 | | |
| S10 (Aspheric) | −44.985401 | 0.000000 | |
| | K: −42932.44 A: 0.760031E−01 B: −.813015E−01 | | |
| | C: 0.414602E−01 D: −.119043E−01 E: 0.599040E−03 | | |
| | F: 0.420413E−03 G: 0.258764E−14 H: −.653282E−14 | | |
| | J: −.903077E−15 | | |
| S11 | INFINITY | 0.695000Z | |
| | | 0.567000 | |
| S12 | INFINITY | 0.100000z | “CG” |
| | | 0.60000 | |
| S13 | INFINITY | 0.000000 | |
| Image plane | INFINITY | 0.000000 | |

TABLE 3

| | | |
|---|---|---|
| Information storage medium | BD | HD DVD |

| Wavelength | | 408 nm | 408 nm |
|---|---|---|---|
| Refractive index | BK7_Schott | 1.529817 | 1.529817 |
| | LaF2_HOYA | 1.772138 | 1.772138 |
| | “CG” | 1.62 | 1.62 |

| | | |
|---|---|---|
| Numerical aperture (NA) | 0.85 | 0.65 |
| Focal length | 2.35 mm | 2.33 mm |
| Hologram diffraction order | 0th | 1st |

Referring to Tables 2 and 3, the active compensation device 20 includes the two transparent substrates 2 and 7, the holographic pattern 6 is adjacent to the material layer 4 and formed on the surface S4 of the transparent substrate 7 which is disposed on the side of the active compensation device 20 from which light is emitted, and the holographic pattern 6 diffracts the incident light to form a zeroth-order light beam when the BD 10a is used (that is, it transmits the incident light without diffraction), and diffracts the incident light to form a first-order light beam when the HD DVD 10b is used. Since the material layer 4 is thinner than the transparent substrates 2 and 7, the thickness of the material layer 4 is not considered in the design stage.

C1, C2, C3, and C4 in Table 2 denote hologram phase coefficients, and HOE means hologram optical element.

S9 and S10 in Table 2 denote two aspheric surfaces of the objective lens 30, K denotes a conic constant in the equation of an aspheric surface, and A, B, C, D, E, F, G, H, and J denote aspheric coefficients.

In rotational symmetry form, the hologram phase coefficients are given by the following equation:

$$φ = \frac{2 π}{{λ}_{0}} {\sum }_{n} {C}_{n} {r}^{2 n} \qquad ( 3 )$$

where C denotes a hologram phase coefficient, r denotes a radius of curvature, AO denotes a wavelength, and φ denotes a phase.

In Table 2, both surfaces of the objective lens 30 are aspheric.

When a depth from the apex of the aspheric surfaces of the objective lens 30 is z, the equation of the aspheric surfaces of the objective lens 30 is given by

$$z = \frac{{ch}^{3}}{1 + \sqrt{1 - ( 1 + K ) {c}^{2} {h}^{2}}} + {Ah}^{4} + {Bh}^{6} + {Ch}^{8} + {Dh}^{10} + {Eh}^{12} + {Fh}^{14} + {Gh}^{16} + {Hh}^{18} + {Jh}^{20} \qquad ( 4 )$$

where h denotes a height from an optical axis, c denotes a curvature, K denotes a conic coefficient, and A through J denote aspheric coefficients.

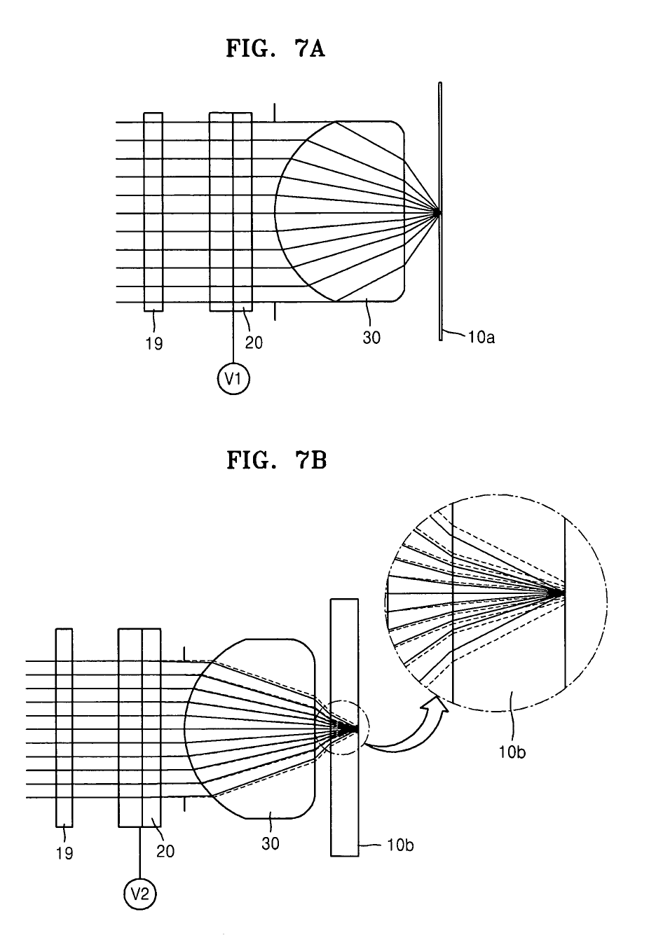

FIGS. 7A and 7B show optical paths of light passing through the active compensation device 20 and the objective lens 30 which are designed according to the data of Table 2, with the objective lens 30 being designed to be compatible the BD 10a and having a focal length of 2.35 mm and designed under conditions that a wavelength is 408 nm, an NA is 0.85, and the information storage medium 10 (i.e., the BD 10a) has a thickness of 0.1 mm. FIG. 7A shows that incident light is transmitted through the active compensation device 20 without being diffracted and is focused on the BD 10a when the voltage V1 is applied to the active compensation device 20. FIG. 7B shows that incident light is diffracted when it passes through the active compensation device 20 when the voltage V2 is applied to the active compensation device 20. Polarized light, e.g., P-polarized light, which is indicated by a solid line in FIG. 7B, is diffracted by the active compensation device 20 and this is focused on the HD DVD 10b having a thickness of 0.6 mm which is different from the thickness of 0.1 mm used in the design of the objective lens 30 (i.e., the thickness of the BD 10a), while orthogonally polarized light, e.g., S-polarized light, which is indicated by a dotted line in FIG. 7B, is not diffracted by the active compensation device 20, and thus is not focused on the HD DVD 10b. Referring to FIG. 7B, since the S-polarized light which is not focused on the HD DVD 10b has a diameter of approximately 150 μm on the HD DVD 10b, spherical aberration is not corrected with respect to the S-polarized light. However, as described above in connection with FIGS. 5 and 6B, almost none of the unfocused S-polarized light reflected from the HD DVD 10b is incident on the effective receiving surface of the photodetector 18, thereby barely affecting the signals detected by the photodetector 18.

Although the light incident from the light source 11 onto the wave plate 19 is P-polarized light and the active compensation device 20 changes a divergence angle of the P-polarized light, the invention is not limited to this configuration, and various modifications can be made in this regard. For example, light incident from the light source 11 onto the wave plate 19 may be P- or S-polarized light and the active compensation device 20 may change a divergence angle of the S-polarized light.

Since the compatible optical pickup according to an aspect of the invention as described above uses the single active compensation device 20, when information is reproduced from the HD DVD 10b using the photodetector 18 optimized for the BD 10a, offset does not occur in focusing and tracking signals detected by the photodetector 18, in contrast to the offset that occurs in a device in the related art.

That is, when two liquid crystal devices are used as in the device disclosed in Japanese Patent Application Publication No. 2002-319172, a light distribution detected by a photodetector may change depending on the type of information storage medium being used due to a concentricity error between the two liquid crystal devices.

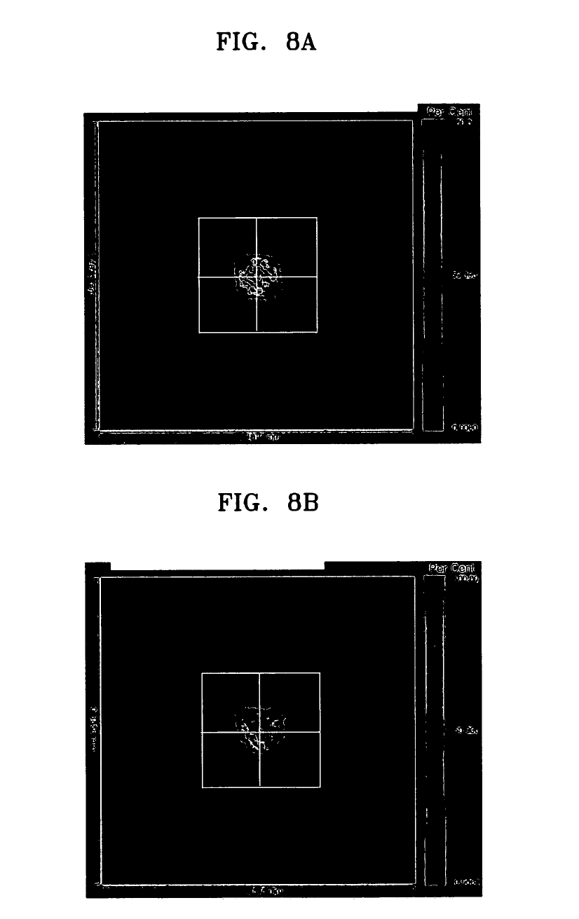

FIG. 8A shows a light distribution on a photodetector in the device in the related when there is no concentricity error between a liquid crystal device that affects light reflected by an information storage medium to the photodetector and a liquid crystal device that affects light traveling from a light source to the information storage medium. FIG. 8B shows a light distribution on the photodetector in the device in the related art when there is a concentricity error of 10 μm between the liquid crystal device that affects light reflected by the information storage device to the photodetector and the liquid crystal device that affects light traveling from the light source to the information storage medium.

Referring to FIGS. 8A and 8B, when there is a concentricity error between the two liquid crystal devices, the light distribution detected by the photodetector 18 changes, thereby generating an offset in focusing and tracking signals detected by the photodetector.

However, since the compatible optical pickup according to an aspect of the invention uses only the single active compensation device 20, light traveling from the light source 11 to the information storage medium 10 and light reflected by the information storage medium 10 to the photodetector 18 both pass through the same active compensation device 20, resulting in no offset in the focusing and tracking signals detected by the photodetector.

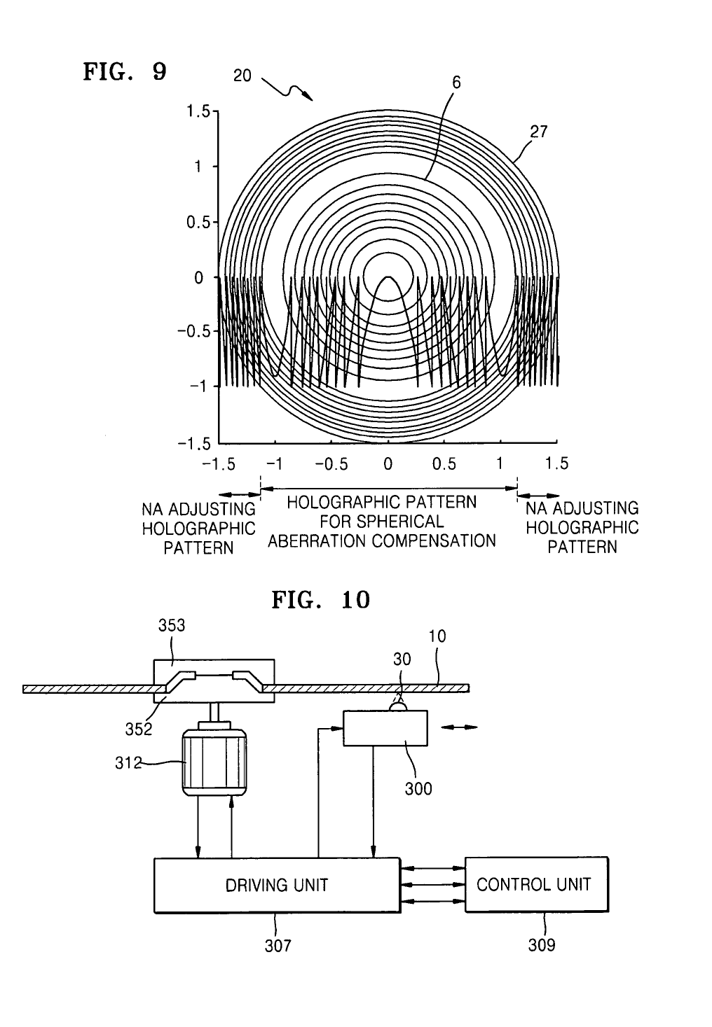

Although the active compensation device 20 includes the holographic pattern 6 formed on the surface of the transparent substrate 7 adjacent to the material layer 4 to change a divergence angle of incident light, the active compensation device 20 may further include an NA adjusting holographic pattern 27 formed at the outer circumference of the holographic pattern 6 as shown in FIG. 9.

While an effective NA required by the BD 10a is 0.85, an effective NA required by the HD DVD 10b is 0.65. Accordingly, when the voltage V2 suitable for the HD DVD 10b is applied to the active compensation device 20 to diffract incident light, an NA adjusting means is required to prevent light outside an area of the radial range of the objective lens 30 corresponding to the NA of 0.65 required by the HD DVD 10b from being focused on the HD DVD 10b.

FIG. 9 shows a plan view and a sectional view of a blazed-type holographic pattern 6 and an NA adjusting holographic pattern 27 formed on a transparent substrate 2 and/or 7 of the active compensation device 20.

Referring to FIG. 9, the holographic pattern 6 is be formed in a region inside an effective diameter of 2.4 mm (a radius of 1.2 mm) corresponding to the NA of 0.65 of the HD DVD 10b, and the NA adjusting holographic pattern 27 for adjusting the NA of the objective lens 30 is formed in a region outside the radius of 1.2 mm.

For example, when the radius corresponding to the NA of 0.85 of the BD 10a is 1.5 mm, the radius corresponding to the NA of 0.65 of the HD DVD 10b is approximately 1.2 mm. To adjust the NA of the objective lens 30, a phase profile for changing a divergence angle of light is formed inside the radius of 1.2 mm, and a phase profile for adjusting the NA of the objective lens 30 is formed outside the radius of 1.2 mm.

When the active compensation device 20 operates to adjust the NA of the objective lens 30 using the NA adjusting holographic pattern 27, light within a radius of 1.2 mm is focused to form a light spot for recording/reproduction on the information storage surface of the HD DVD 10b. On the other hand, light outside the radius of 1.2 mm is not focused by the NA adjusting holographic pattern 27, thereby barely affecting recording and reproducing operations of the HD DVD 10b.

Accordingly, when the BD10a is used, the active compensation device 20 including the NA adjusting holographic pattern 27 formed at the outer circumference of the holographic pattern 6 that adjusts a divergence angle of the incident light can transmit light without diffraction by means of the holographic pattern 6 and the NA adjusting holographic pattern 27. In contrast, when the HD DVD 10b is used, the active compensation device 20 diffracts light in the region corresponding to the NA of 0.65 using the holographic pattern 6 to change a divergence angle of the incident light, so that an angle at which the incident light is incident on the objective lens 30 is changed. As a result, spherical aberration caused by a difference between the thickness of 0.1 mm used in the design of the objective lens 30 (i.e., the thickness of the BD 10a) and the thickness of 0.6 mm of the HD DVD 10b is corrected, thereby enabling the objective lens 30 to focus an optimal light spot on the HD DVD 10b. Also, the active compensation device 20 diffracts light outside the region corresponding to the NA of 0.65 using the NA adjusting holographic pattern 27 so that such light is not focused on the HD DVD 10b, thereby barely affecting the recording and reproducing operations of the HD DVD 10b.

FIG. 10 shows an optical recording and/or reproducing apparatus employing a compatible optical pickup according to an aspect of the invention.

Referring to FIG. 10, the optical recording and/or reproducing apparatus includes a spindle motor 312 that rotates the information storage medium 10, an optical pickup 300 disposed to be movable at least in a radial direction of the information storage medium 10, a driving unit 307 that drives the spindle motor 312 and the optical pickup 300, and a control unit 309 that controls focus, tracking, and/or tilt servos of the optical pickup 300 and controls the optical pickup 300 to record information on and/or reproduce information from the information medium 10 via the driving unit 307. Reference numeral 352 denotes a turntable that supports the information storage medium 10, and reference numeral 353 denotes a clamp that clamps the information storage medium 10 to the turntable 352.

The optical pickup 300 includes any one of the various compatible optical pickups according to aspects of the invention described above.

Light reflected by the information storage medium 10 is detected by a photodetector of the optical pickup 300 which converts the detected light into an electric signal. The electric signal is input to the control unit 309 through the driving unit 307. The driving unit 307 controls the rotation speed of the spindle motor 312, amplifies an input signal received from the control unit 309, and drives the optical pickup 300 in accordance with the amplified input signal. The control unit 309 provides a focus servo, tracking servo, and/or tilt servo command to the driving unit 307 based on the signal input to the control unit 309 from the driving unit 307 to enable the optical pickup 300 to perform a focusing, tracking, and/or tilting operation. The optical recording and/or reproducing apparatus employing the compatible optical pickup according to an aspect of the invention is compatible with both the BD and the HD DVD. Also, since the optical recording and/or reproducing apparatus employing the compatible optical pickup according to an aspect of the invention uses a single objective lens 30 and a single active compensation device 20, the optical recording and/or reproducing apparatus can operate at a higher speed than an optical recording and/or reproducing apparatus in the related art using a structure in which one lens holder and two or more objective lenses are used, or a structure in which two liquid crystal devices are used.

Since the compatible optical pickup according to an aspect of the invention as described above can compatibly use information storage media complying with different information storage medium standards specifying different thicknesses and light having a same wavelength using only one light source, one objective lens, and one active compensation device, the structure of the compatible optical pickup can be simplified and the number of components can be reduced compared to conventional optical pickups.

Furthermore, since only one objective lens and only one active compensation device are used in the compatible optical pickup according to an aspect of the invention, costs are reduced, weight is reduced, high-speed operation is achieved, a light intensity distribution detected by the photodetector is barely changed, and offset caused by a concentricity error between two liquid crystal devices is avoided.

Although several embodiments of the invention has been shown and described, it would be appreciated by those skilled in the art that changes may be made in these embodiments without departing from the principles and spirit of the invention, the scope of which is defined in the claims and their equivalents.

What is claimed is:

1. An active compensation device comprising:
two transparent substrates;
a material layer interposed between the transparent substrates and having a refractive index that is actively switched according to a voltage applied to the material layer; and
a holographic pattern formed adjacent to the material layer on a surface of at least one of the transparent substrates to control a divergence angle of incident light by transmitting the incident light without diffraction or diffracting the incident light according to the refractive index of the material layer.

2. The active compensation device of claim 1, wherein the material layer is a liquid crystal layer having a refractive index that is actively switched according to the voltage applied to the material layer.

3. The active compensation device of claim 1, wherein the refractive index of the material layer is actively switched according to the voltage applied to the material layer to be equal to or different from a refractive index of the at least one of the transparent substrates on which the holographic pattern is formed.

4. The active compensation device of claim 1, wherein a difference Δn between a refractive index of the at least one of the transparent substrates on which the holographic pattern is formed and the refractive index of the material layer, a depth d of the holographic pattern, a wavelength x of the incident light, and an order m of diffracted light produced by the holographic pattern satisfy the following equation:
(Δn·λ−1)d=m·λ.

5. The active compensation device of claim 1, further comprising a numerical aperture adjusting holographic pattern formed at an outer circumference of the holographic pattern.

6. The active compensation device of claim 1, wherein when the voltage applied to the material layer is a first voltage, the refractive index of the material layer is substantially equal to a refractive index of the at least one of the transparent substrates on which the holographic pattern is formed, thereby causing the holographic pattern to transmit the incident light without diffraction; and
wherein when the voltage applied to the material layer is a second voltage different from the first voltage, the refractive index of the material layer is different from the refractive index of the at least one of the transparent substrates on which the holographic pattern is formed, thereby causing the holographic pattern to diffract the incident light.

7. An optical pickup comprising:
a light source that emits light having a predetermined wavelength;
an objective lens that focuses incident light originating from the light source on an information storage medium and is compatible with a first information storage medium standard that specifies a first thickness and light having the predetermined wavelength;
an optical path changer, interposed between the light source and the objective lens, that changes an optical path of light traveling to and from the objective lens;
a photodetector that receives light that is reflected by the information storage medium and passes through the objective lens and the optical path changer;
an active compensation device according to claim 1, interposed between the optical path changer and the objective lens, that actively controls an angle at which the incident light originating from the light source is incident on the objective lens to make the objective lens compatible with both the first information storage medium standard and a second information storage medium standard that specifies a second thickness different from the first thickness and light having the predetermined wavelength; and
a wave plate, interposed between the optical path changer and the active compensation device, that changes a polarization of light traveling to and from the active compensation device.

8. The optical pickup of claim 7, wherein the material layer is a liquid crystal layer having a refractive index that is actively switched according to the voltage applied to the material layer.

9. The optical pickup of claim 7, wherein the refractive index of the material layer is actively switched according to the voltage applied to the material layer to be equal to or different from a refractive index of the at least one of the transparent substrates on which the holographic pattern is formed.

10. The optical pickup of claim 7, wherein a difference Δn between a refractive index of the at least one of the transparent substrates on which the holographic pattern is formed and the refractive index of the material layer, a depth d of the holographic pattern, a wavelength λ of the incident light, and an order m of diffracted light produced by the holographic pattern satisfy the following equation:
(Δn·λ−1)d=m·λ.

11. The optical pickup of claim 7, further comprising a numerical aperture adjusting holographic pattern, formed at an outer circumference of the holographic pattern, that adjusts a numerical aperture of the objective lens so that the objective lens has a first numerical aperture specified by the first information storage medium standard when the information storage medium complies with the first information storage medium standard, and has a second numerical aperture specified by the second information storage medium standard and different from the first numerical aperture when the information storage medium complies with the second information storage medium standard.

12. The optical pickup of claim 11, wherein the predetermined wavelength of the light source is in a range of 400-420 nm, the first thickness specified by the first information storage medium standard is 0.1 mm, the first numerical aperture specified by the first information storage medium standard is substantially 0.85, the second thickness specified by the second information storage medium standard is 0.6 mm, and the second numerical aperture specified by the second information storage medium is substantially 0.65.

13. The optical pickup of claim 7, wherein the predetermined wavelength of the light source is in a range of 400-420 nm, the first information storage medium standard is a Blu-ray disc (BD) standard, and the second information storage medium standard is a high-definition digital versatile disc (HD DVD) standard.

14. The optical pickup of claim 7, wherein the optical path changer is a polarization-dependent optical path changer.

15. The optical pickup of claim 7, wherein when the voltage applied to the material layer is a first voltage, the refractive index of the material layer is substantially equal to a refractive index of the at least one of the transparent substrates on which the holographic pattern is formed, thereby causing the holographic pattern to transmit the incident light without diffraction so that the incident light originating from the light source is incident on the objective lens at a first angle to make the objective lens compatible with the first information storage medium standard; and
wherein when the voltage applied to the material layer is a second voltage different from the first voltage, the refractive index of the material layer is different from the refractive index of the at least one of the transparent substrates on which the holographic pattern is formed, thereby causing the holographic pattern to diffract the incident light so that the incident light originating from the light source is incident on the objective lens at a second angle different from the first angle to make the objective lens compatible with the second information storage medium standard.

16. The optical pickup of claim 15, wherein when the holographic pattern transmits the incident light without diffraction, the incident light originating from the light source is incident on the objective lens as a parallel light beam; and
wherein when the holographic pattern diffracts the incident light, the incident light originating from the light source is incident on the objective lens as a diverging light beam.

17. An optical recording and/or reproducing apparatus comprising:
an optical pickup according to claim 7 disposed to be movable at least in a radial direction of an information storage medium; and
a control unit that controls the optical pickup to record information on and/or reproduce information from the information storage medium.

18. The optical recording and/or reproducing apparatus of claim 17, wherein the material layer is a liquid crystal layer having a refractive index that is actively switched according to the voltage applied to the material layer.

19. The optical recording and/or reproducing apparatus of claim 17, wherein the refractive index of the material layer is actively switched according to the voltage applied to the material layer to be equal to or different from a refractive index of the at least one of the transparent substrates on which the holographic pattern is formed.

20. The optical recording and/or reproducing apparatus of claim 17, wherein a difference Δn between a refractive index of the at least one of the transparent substrates on which the holographic pattern is formed and the refractive index of the material layer, a depth d of the holographic pattern, a wavelength λ of the incident light, and an order m of diffracted light produced by the holographic pattern satisfy the following equation:
(Δn·λ−1)d=m·λ.

21. The optical recording and/or reproducing apparatus of claim 17, further comprising a numerical aperture adjusting holographic pattern, formed at an outer circumference of the holographic pattern, that adjusts a numerical aperture of the objective lens so that the objective lens has a first numerical aperture specified by the first information storage medium standard when the information storage medium complies with the first information storage medium standard, and has a second numerical aperture specified by the second information storage medium standard and different from the first numerical aperture when the information storage medium complies with the second information storage medium standard.

22. The optical recording and/or reproducing apparatus of claim 21, wherein the predetermined wavelength of the light source is in a range of 400-420 nm, the first thickness specified by the first information storage medium standard is 0.1 mm, the first numerical aperture specified by the first information storage medium standard is substantially 0.85, the second thickness specified by the second information storage medium standard is 0.6 mm, and the second numerical aperture specified by the second information storage medium standard is substantially 0.65.

23. The optical recording and/or reproducing apparatus of claim 17, wherein the predetermined wavelength of the light source is in a range of 400-420 nm, the first information storage medium standard is a Blu-ray disc (BD) standard, and the second information storage medium standard is high-definition digital versatile disc (HD DVD) standard.

24. The optical recording and/or reproducing apparatus of claim 17, wherein the optical path changer is a polarization-dependent optical path changer.

25. The optical recording and/or reproducing apparatus of claim 17, wherein when the voltage applied to the material layer is a first voltage, the refractive index of the material layer is substantially equal to a refractive index of the at least one of the transparent substrates on which the holographic pattern is formed, thereby causing the holographic pattern to transmit the incident light without diffraction so that the incident light originating from the light source is incident on the objective lens at a first angle to make the objective lens compatible with the first information storage medium standard; and
wherein when the voltage applied to the material layer is a second voltage different from the first voltage, the refractive index of the material layer is different from the refractive index of the at least one of the transparent substrates on which the holographic pattern is formed, thereby causing the holographic pattern to diffract the incident light so that the incident light originating from the light source is incident on the objective lens at a second angle different from the first angle to make the objective lens compatible with the second information storage medium standard.

26. The optical recording and/or reproducing apparatus of claim 25, wherein when the holographic pattern transmits the incident light without diffraction, the incident light originating from the light source is incident on the objective lens as a parallel light beam; and
wherein when the holographic pattern diffracts the incident light, the incident light originating from the light source is incident on the objective lens as a diverging light beam.

27. An optical pickup comprising:
a single light source that emits light having a predetermined wavelength specified by a first information storage medium standard and a second information storage medium standard different from the first information storage medium standard;
a single objective lens that is compatible with the first information storage standard but is not compatible with the second information storage medium standard; and
a single active compensation device, interposed between the single light source and the single objective lens, that transmits incident light originating from the single light source without modification when a first information storage medium complying with the first information storage medium standard is being used so that the single objective lens focuses the unmodified incident light on the first information storage medium without aberration, and modifies the incident light originating from the single light source when a second information storage medium complying with the second information storage medium standard is being used so that the single objective lens focuses the modified light on the second information storage medium without aberration, thereby making the single objective lens compatible with the second information storage medium standard.
